(19) United States
(12) Patent Application Publication
(10) Pub. No.: US 2013/0286657 A1
(43) Pub. Date: Oct. 31, 2013

(54) OPTICAL LENS AND LIGHT SOURCE MODULE HAVING THE SAME

(71) Applicants: CHIN-CHUNG CHEN, Tu-Cheng (TW); SHENG-JIE QIAO, Foshan City (CN)

(72) Inventors: CHIN-CHUNG CHEN, Tu-Cheng (TW); SHENG-JIE QIAO, Foshan City (CN)

(21) Appl. No.: 13/631,758

(22) Filed: Sep. 28, 2012

(30) Foreign Application Priority Data
Apr. 26, 2012 (CN) 201210125761.0

(51) Int. Cl. F21V 13/04

(52) U.S. Cl. 362/308; 362/327

(57) ABSTRACT

A lens for covering a light source to diverge light from the light source includes a light incident surface covering the light source, a light outputting surface positioned at lateral sides of the light incident surface; and a light reflecting surface positioned away from the light incident surface and interconnecting the light outputting surface. A reflectivity of the light reflecting surface is greater than a transmissivity thereof. Part of the light striking to the light reflecting surface is reflected by the light reflecting surface and traveling out of the lens via the light outputting surface. The other part of the light strikes to the light reflecting surface traveling out of the lens via the light reflecting surface. The light traveling through the lens has a viewing angle greater than 180 degrees.

### BACKGROUND

1. Technical Field

The present disclosure generally relates to optical devices, and particularly to an optical lens and a light source module which has the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, a conventional LED die has a viewing angle of about 120 degrees, and an uneven light field with high light intensity at a center thereof and low light intensity at a periphery thereof. However, if a conventional lamp is replaced by an LED lamp, the LED lamp is required to achieve a viewing angle of about 180 degrees under the rule of Energy Star of America.

Therefore, it is necessary to provide an optical lens and a light source module to overcome the above-mentioned shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic, isometric view of an optical lens in accordance with an exemplary embodiment of the present disclosure.

FIG. 2 is a cross-sectional view of the optical lens of FIG. 1, taken along line II-II thereof.

FIG. 3 is a cross-sectional view of the optical lens of FIG. 1, taken along line thereof.

FIG. 4 is a coordinate graph showing a light intensity distribution of the light source device having the optical lens of FIG. 1 at angles between 0 degree and 180 degrees of illumination.

FIG. 5 is a coordinate graph showing a light intensity distribution of the light source device having the optical lens of FIG. 1 at angles between 90 degrees and 270 degrees of illumination.

### DETAILED DESCRIPTION

Reference will now be made to the drawings to describe an exemplary embodiment of the present optical lens and the light source module having the same.

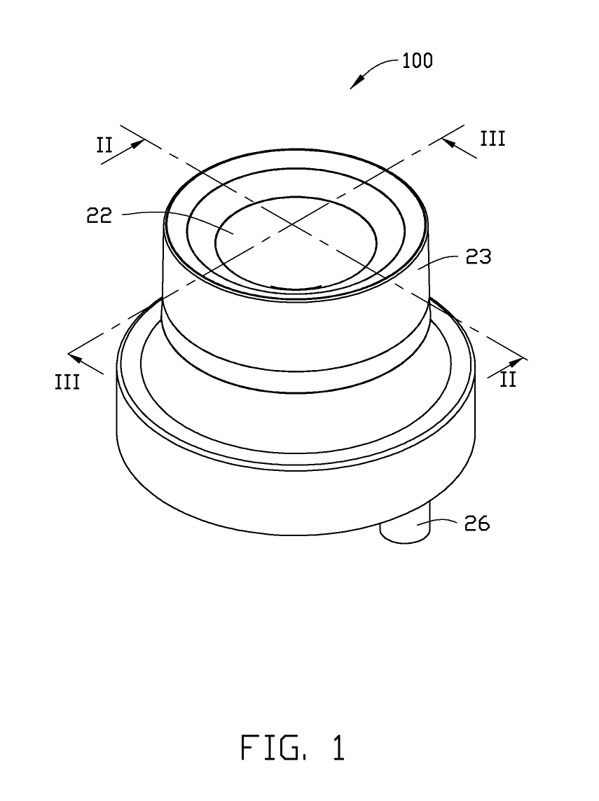

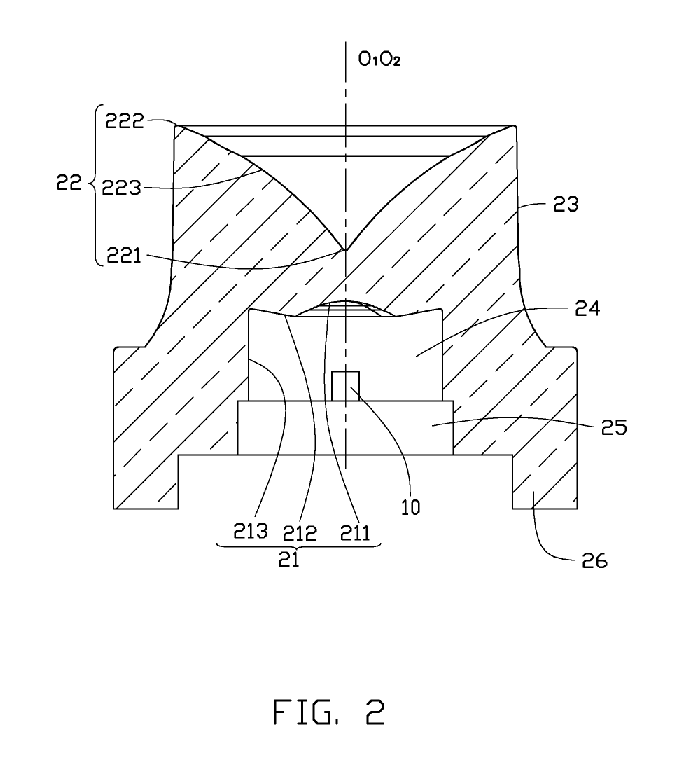

Referring to FIG. 1 and FIG. 2, a light source module 100, in accordance with an exemplary embodiment of the present disclosure, includes a light source 10 and an optical lens 20 located on the light source 10. In this embodiment, the light source 10 is an LED.

The lens 20 includes a light incident surface 21, a light reflecting surface 22 and a light outputting surface 23. The light incident surface 21 is positioned opposite to the light reflecting surface 22. The outputting surface 23 is positioned at lateral sides of the light incident surface 21.

The light incident surface 21 is concave, and includes a first concave surface 211, a second concave surface 212 and a vertical surface 213. The first concave surface 211 is positioned at a middle portion of the lens 20 and symmetrical with respect to an optical axis O₁O₂ of the lens 20. The first concave surface 211 directly faces the light source 10 and recesses away from the light source 10. The first concave surface 211 is used for diverging light radiated from the light source 10. The light radiated from the light source 10 travels through the first concave surface 211, and then is diverged from the optical axis O₁O₂ of the lens 20. The second concave surface 212 extends aslant from peripheral edges of the first concave surface 211 and away from the light source 10. The vertical surface 213 is annular, and extends downwardly from peripheral edges of the second concave surface 212 to define a hollow and cylindrical receiving cavity 24. The light source 10 is received in the receiving cavity 24. Alternatively, the light incident surface 21 can also be convex, or planar.

The lens 20 further includes a bottom cavity 25 in communication with the receiving cavity 24 for receiving other structures, such as a circuit board (not illustrated) supporting the light source 10. The lens 20 further includes a supporting post 26 extending from a bottom portion of the lens 20 downwardly. In this embodiment, there are two symmetrical supporting posts 26 extending from a bottom surface of the lens 20.

The light reflecting surface 22 covers the light source 10. The light reflecting surface 22 is substantially a concave surface recessing towards the light incident surface 21. One part of the light radiated from the light source 10 at a center thereof is reflected by the light reflecting surface 22 towards opposite directions diverging from the optical axis O₁O₂ of the lens 20. The other part of the light radiated from the light source 10 at the center thereof can travel through the light reflecting surface 22 and out of the light source module 100. As such, the light radiated from the light source 10 at the center thereof can travel out of the light source module 100 with a viewing angle greater than 180 degrees. In this embodiment, more light will be reflected by the light reflecting surface 22 because the reflectivity of the light reflecting surface 22 is greater than the transmissivity thereof. An amount of light capable of travelling towards the light reflecting surface 22 depends on an area of the light reflecting surface 22 and a distance between the light reflecting surface 22 and the light source 10.

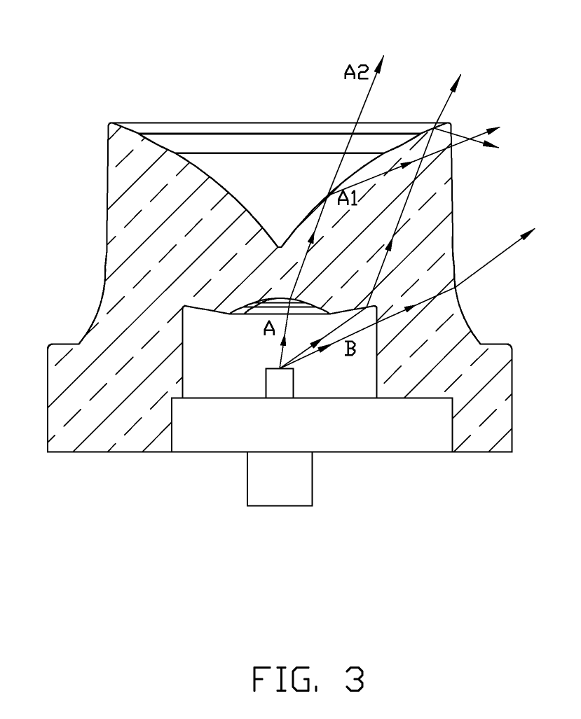

Referring also to FIG. 3, light A is a light beam striking onto the light reflecting surface 22. Light B is a light beam not striking onto the light reflecting surface 22. A biggest angle between the light A and the optical axis O₁O₂ is smaller than a smallest angle between the light B and the optical axis O₁O₂. In other words, the light which has an included angle diverged from the optical axis O₁O₂ smaller than a predetermined angle will totally strike to the light reflecting surface 22 and be labeled as light A. The light A is further designated as light A1 and the other part of light A2. The light A1 can be reflected by the light reflecting surface 22. The light A2 can travel through the light reflecting surface 22, and out of the lens 20. In this embodiment, the light reflecting surface 22 is substantially a reversed taper and symmetrical with respect to the optical axis O₁O₂ of the lens 20. The light reflecting surface 22 includes a lowest point 221 and a plurality of highest points 222. The lowest point 221 is right on the optical axis O₁O₂ of the lens 20. The highest points 222 surround the optical axis O₁O₂ to cooperatively form a circle above the light source 10. A plurality of integral circles 223 are formed between the lowest point 221 and the highest point 222 and interconnect the lowest point 221 and the highest point 222. A cross section of the connected integral circles 223 forms two arcs symmetrical to each other, with respect to the optical axis O₁O₂ of the lens 20. A center of each arc is configured at a lower side of the light reflecting surface 22, as same as the side where the light incident surface 21 is configured. In other words, the light reflecting surface 22 is taper-like curved surface in three dimensions, with a generatrix recessing inward. In alternative embodiments, a curvature radius and a profile of the light reflecting surface 22 can be adjusted to achieve different light fields.

The light outputting surface 23 is positioned at lateral sides of the lens 20. The light outputting surface 23 extends from the highest point 222 downwardly, then extends outward and downwardly, smoothly like an arc, and finally extends perpendicularly and downwardly to contact the bottom of the lens 20. The light which has an included angle diverged from the optical axis O₁O₂ and greater than a predetermined angle, will totally strike to and travel through the outputting surface 23 and be labeled as light B. The light directly traveling through the outputting surface 23 has a same light outputting direction with the light radiated from the light source 10, with a viewing angle smaller than 180 degrees.

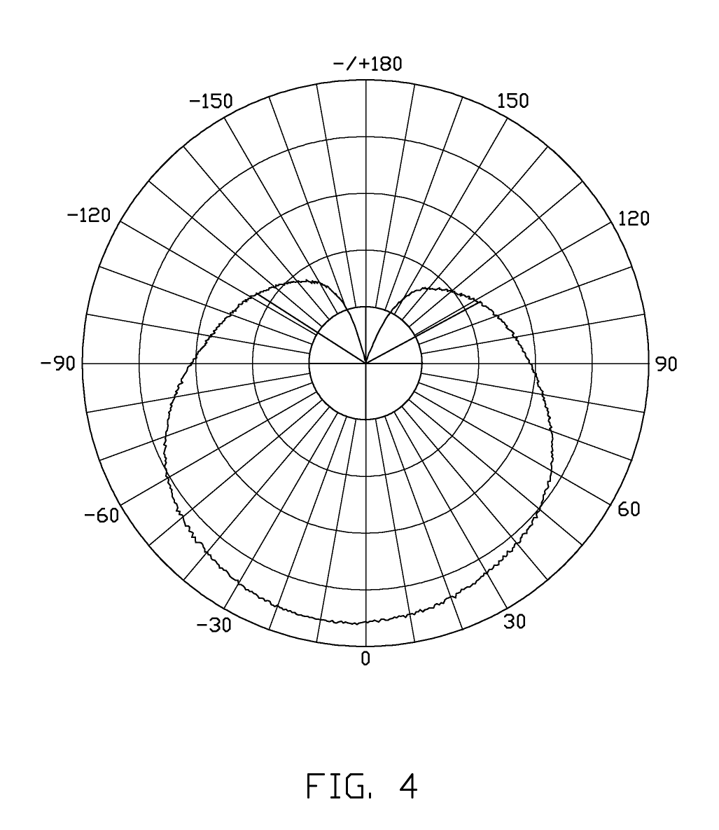

Referring to FIG. 4, a graph having a curve indicating a light intensity (woof) versus a light angle (longitude) of the light source module 100 is shown, wherein the light source module 100 is positioned in a three dimensional area with angles between 0 degree and 180 degrees. The light source module 100 has a viewing angle greater than 180 degrees. An average angle is about 240.9 degrees. The light has the highest intensity at +60 degrees and −60 degrees. The intensity of the light is decreasing beyond a plane where the light source 10 is positioned.

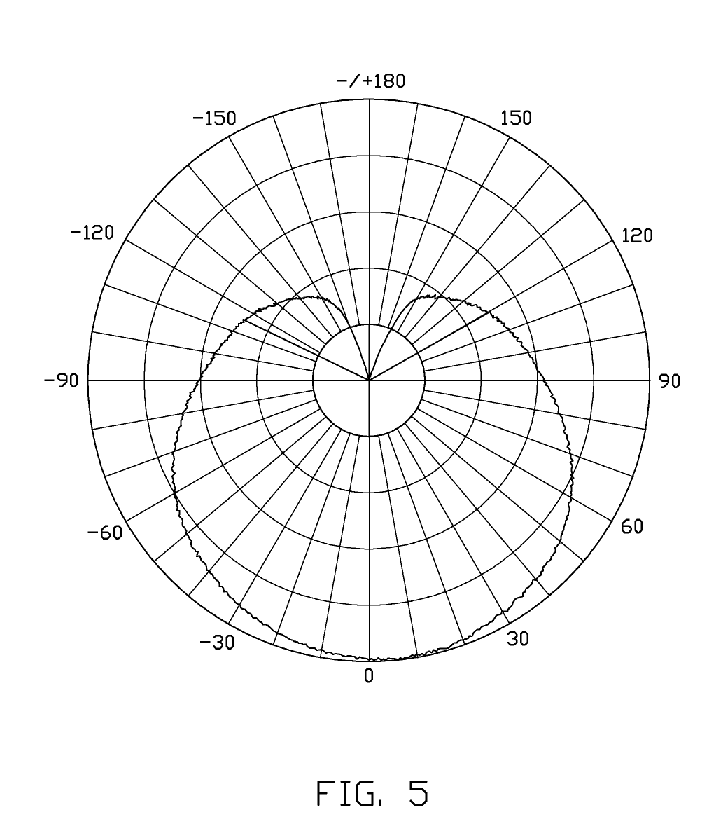

Referring to FIG. 5, a graph having a curve indicating a light intensity (woof) versus a light angle (longitude) of the light source module 100 is shown, wherein the light source module 100 is positioned in an three dimensional area with angles between 90 degrees and 270 degrees. The average angle is about 238.2 degrees. The light intensity versus a light angle of the light source module 100 positioned in the three dimensional area with the angle between 90 degrees and 270 degrees is similar to that in the three dimensional area with the angle between 0 degree and 180 degrees. FIGS. 4 and 5 show that the light source module 100 distributes light evenly in the three dimensional area with different angles and has the viewing angle greater than 180 degrees.

Further, there can be a plurality of lens 20 employed by the light source module 100. The lens 20 can be arranged in a circle to obtain even illumination.

In the present disclosure, the light reflecting surface 22 directly faces the light incident surface 21. The reflectivity of the light reflecting surface 22 is greater than the transmissivity thereof. During operation, part of the light radiated from the light source 10 travels to the light reflecting surface 22, and another part of the light radiated from the light source 10 travels out of the lens 20 through the light outputting surface 23. One part of the light traveled to the light reflecting surface 22 is reflected by the light reflecting surface 22, and travels out of the lens 20 through the light outputting surface 23. Another part of the light traveled to the light reflecting surface 22 directly travels out of the lens 20 through the light reflecting surface 22. The light radiated from the light source 10 can travel out of the lens 20, with a viewing angle greater than 180 degrees. This satisfies the rule of Energy Star of America.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A lens adapted for covering a light source to diverge light radiated from the light source comprising:
a light incident surface facing the light source;
a light outputting surface positioned at lateral sides of the light incident surface; and
a light reflecting surface positioned away from the light incident surface and connected with the light outputting surface, part of the light radiated from the light source traveling to the light reflecting surface, and another part of the light radiated from the light source traveling out of the lens through the light outputting surface, a reflectivity of the light reflecting surface being greater than a transmissivity the light reflecting surface, one part of the light traveled to the light reflecting surface being reflected by the light reflecting surface and traveling out of the lens through the light outputting surface, another part of the light traveled to the light reflecting surface traveling out of the lens through the light reflecting surface, and the light traveling through the lens having a viewing angle greater than 180 degrees.

2. The lens of claim 1, wherein the light reflecting surface is substantially a concave surface recessing towards the light incident surface.

3. The lens of claim 1, wherein the concave light reflecting surface comprises a lowest point and a plurality of highest points, the lowest point is on an optical axis of the lens, and the plurality of highest points surround the optical axis of the lens to cooperatively form a circle above the light source and the lowest point.

4. The lens of claim 3, wherein a plurality of integral circles are formed between the lowest point and the highest points and interconnect the lowest point and the highest points, and a cross section of the connecting integral circles forms two arcs symmetrical to each other with respect to the optical axis of the lens.

5. The lens of claim 1, wherein the light reflecting surface is substantially a reversed taper with a generatrix recessing inward.

6. The lens of claim 1, wherein the light incident surface comprises a first concave surface and a second concave surface, the first concave surface is positioned at a middle portion of the lens and symmetrical with respect to an optical axis of the lens and faces the light source.

7. The lens of claim 6, wherein the second surface extends aslant from peripheral edges of the first concave surface away from the light source.

8. The lens of claim 7, wherein the light incident surface further comprises a vertical surface, the vertical surface extending downwardly from peripheral edges of the second concave surface to define a hollow and cylindrical receiving cavity for the light source.

9. A light source module comprising:
a light source;
a lens located on the light source to diverge light from the light source, the lens comprising:
a light incident surface facing the light source;
a light outputting surface positioned at lateral sides of the light incident surface; and
a light reflecting surface positioned away from the light incident surface and connected with the light outputting surface, a reflectivity of the light reflecting surface being greater than a transmissivity the light reflecting surface, during operation, part of the light radiated from the light source traveling to the light reflecting surface, and another part of the light radiated from the light source traveling out of the lens through the light outputting surface, one part of the light traveling to the light reflecting surface being reflected by the light reflecting surface and out of the lens through the light outputting surface, another part of the light traveling to the light reflecting surface traveling out of the lens through the light reflecting surface, and the light traveling through the lens having a viewing angle greater than 180 degrees.

10. The light source module of claim 9, wherein the light source is an LED light source.

11. The light source module of claim 9, wherein the light reflecting surface is substantially a concave surface recessing towards the light incident surface.

12. The light source module of claim 9, wherein the concave light reflecting surface comprises a lowest point and a plurality of highest points, the lowest point is on an optical axis of the lens, and the plurality of highest points surround the optical axis of the lens to cooperatively form a circle above the light source and the lowest point.

13. The light source module of claim 12, wherein a plurality of integral circles are formed between the lowest point and the highest points and interconnect the lowest point and the highest points, and a cross section of the connecting integral circles forms two arcs symmetrical to each other with respect to the optical axis of the lens.

14. The light source module of claim 9, wherein the light reflecting surface is substantially a reversed taper with a generatrix recessing inward.

15. The light source module of claim 9, wherein the lens further comprises a receiving cavity, the receiving cavity is surrounded by the light incident surface of the lens and a vertical surface extending downwardly from peripheral edges of the light incident surface together, and the light source is received in the receiving cavity.
